(19) United States
(12) Patent Application Publication
(10) Pub. No.: US 2006/0178948 A1
(43) Pub. Date: Aug. 10, 2006

(54) Point-of-sales print apparatus, print order processing method and print order processing program

(75) Inventor: Shinya Yamada, Asaka-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Fuji Photo Film Co., Ltd., Minami-Ashigara-shi (JP)

(21) Appl. No.: 11/346,245

(22) Filed: Feb. 3, 2006

(30) Foreign Application Priority Data
Feb. 8, 2005 (JP) NO.2005-031960

(51) Int. Cl. G06Q 30/00

(52) U.S. Cl. 705/26

(57) ABSTRACT

In the point-of-sales print apparatus according to the present invention, it is possible to input an amount appropriated to payment at any timing while print order information is inputted and continuously input new order information as far as the inputted amount is equal to or above a print fee. Accordingly, it is possible to sequentially perform print output based on order information sequentially inputted by a customer while securing an amount required for settlement of a print fee in advance. Especially, it is also possible to input new order information when print output in accordance with print order information inputted previously is being performed.

### BACKGROUND OF THE INVENTION

1. Field of the Invention

The present invention relates to a technique for processing a print order in a point-of-sales print apparatus.

2. Description of the Related Art

In recent years, point-of-sales print apparatuses have widely spread which are to be installed at the front of various stores for printing images freely brought to the stores by customers. In conventional point-of-sales print apparatuses, print processing starts after a customer decides the content of an order and throws in money for the price, and the function of accepting an order is stopped until the print processing is completed. For example, according to Japanese Patent Application Laid-Open No. 2002-329250, when a customer presses a button for starting print by touching a screen, a specified number of prints of an image selected by the customer are automatically outputted. During the print, a screen indicating that the print is being performed is displayed on a display device. When all the prints are outputted, a screen indicating that the print has ended is displayed on the display device. The automatic print selling apparatus prompts the customer to confirm whether he will terminate the print or print another image. When the customer instructs termination of the print by touching the screen while the print finish screen is displayed, change is returned to the customer from an accounting device if there is any remainder after subtracting the price from the amount thrown in, and then the processing is terminated. If the customer instructs further print to be performed, then the screen returns to a screen for viewing image data to accept a new print order.

### SUMMARY OF THE INVENTION

In the point-of-sales print apparatus of Japanese Patent Application Laid-Open No. 2002-329250, since the screen returns to the view screen in response to completion of the print processing, the customer cannot place a new order until the print processing ends. That is, once the user decides the content of a print order, he cannot do anything until the print processing ends, even if he wants to place an additional print order during the print processing. Once the print processing starts, it takes several to dozen minutes until the processing ends. To keep the customer waiting without doing anything during the period may make him feel irritated, and this may cause customer churn. The present invention has been made in consideration of this problem, and its object is to enable a user to place an additional order at any timing irrespective of end of print processing.

In order to solve the above problem, a point-of-sales print apparatus according to the present invention is a point-of-sales print apparatus having an order acceptance section which accepts input of a print order information including specification of an image to be printed and the number of prints and input of an instruction to start print output, a fee calculation section which calculates a print fee based on a content of the print order information, a settlement section to which an amount appropriated to payment, an amount to be appropriated to payment for the print fee, is inputted and which settles the print fee from the amount appropriated to payment, and a print output section which outputs prints of an image in accordance with the print order information in response to the settlement, wherein the settlement section accepts input of the amount appropriated to payment at any timing while the print order information is inputted, the order acceptance section enables input of an instruction to start print output in accordance with the print order information if the amount appropriated to payment is equal to or above the print fee, the print output section performs print output in accordance with the print order information, in response to input of the instruction to start print output, and the order acceptance section further accepts new print order information after the instruction to start print output is inputted.

In the point-of-sales print apparatus according to the present invention, it is possible to input an amount appropriated to payment at any timing while print order information is inputted and continuously input new order information as far as the inputted amount is equal to or above a print fee. Accordingly, it is possible to sequentially perform print output based on order information sequentially inputted by a customer while securing an amount required for settlement of a print fee in advance. Especially, it is also possible to input new order information when print output in accordance with print order information inputted previously is being performed.

The order acceptance section accepts input of an instruction to finish a print order, and the settlement section may make settlement of a print fee in response to the input of an instruction to finish a print order.

The point-of-sales print apparatus may be further provided with a display section which displays an indication to the effect that input of the instruction to start print output is possible if the amount appropriated to payment is equal to or above the print fee.

The display section may display a warning if the amount appropriated to payment is below the print fee.

A print order processing method is also included in the present invention, which comprises the steps of: accepting input of a print order information including specification of an image to be printed and the number of prints, accepting input of an amount appropriated to payment, an amount to be appropriated to payment for a print fee at any timing while the print order information is inputted, calculating a print fee based on a content of the print order information, enabling input of an instruction to start print output in accordance with the print order information if the amount appropriated to payment is equal to or above the print fee, performing print output in accordance with the print order information, in response to input of the instruction to start print output, and further accepting a new print order information after the instruction to start print output is inputted.

A print order processing program is also included in the present invention which causes a computer to perform the steps of: accepting input of a print order information including specification of an image to be printed and the number of prints, accepting input of an amount appropriated to payment, an amount to be appropriated to payment for a print fee at any timing while the print order information is inputted, calculating a print fee based on a content of the print order information, enabling input of an instruction to start print output in accordance with the print order information if the amount appropriated to payment is equal to or above the print fee, performing print output in accordance with the print order information, in response to input of the instruction to start print output, and further accepting new print order information after the instruction to start print output is inputted.

According to the present invention, it is possible to input an amount appropriated to payment at any timing while print order information is inputted and continuously input a new order information as far as the inputted amount is equal to or above a print fee. Accordingly, it is possible to sequentially perform print output based on order information sequentially inputted by a customer while securing an amount required for settlement of a print fee in advance. Especially, it is also possible to input a new order information when print output in accordance with print order information inputted previously is being performed.

### BRIEF DESCRIPTION OF THE DRAWINGS

FIG. 1 is a front view of a point-of-sales print apparatus according to a preferred embodiment of the present invention;

FIG. 2 is a block configuration diagram of the point-of-sales print apparatus;

FIG. 3 is a block diagram showing a program to be executed by the point-of-sales print apparatus;

FIG. 4 is a flowchart showing the flow of print order processing;

FIG. 5 shows a display example of a print order screen from which it is impossible to instruct start of print;

FIG. 6 shows a display example of a print order screen from which it is possible to instruct start of print; and

FIG. 7 shows an example of a warning display.

### DETAILED DESCRIPTION OF THE PREFERRED EMBODIMENTS

A preferred embodiment of the present invention will be described below with reference to accompanying drawings.

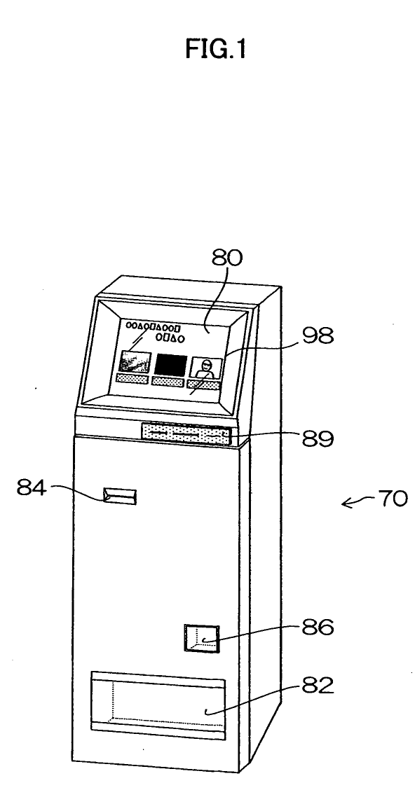

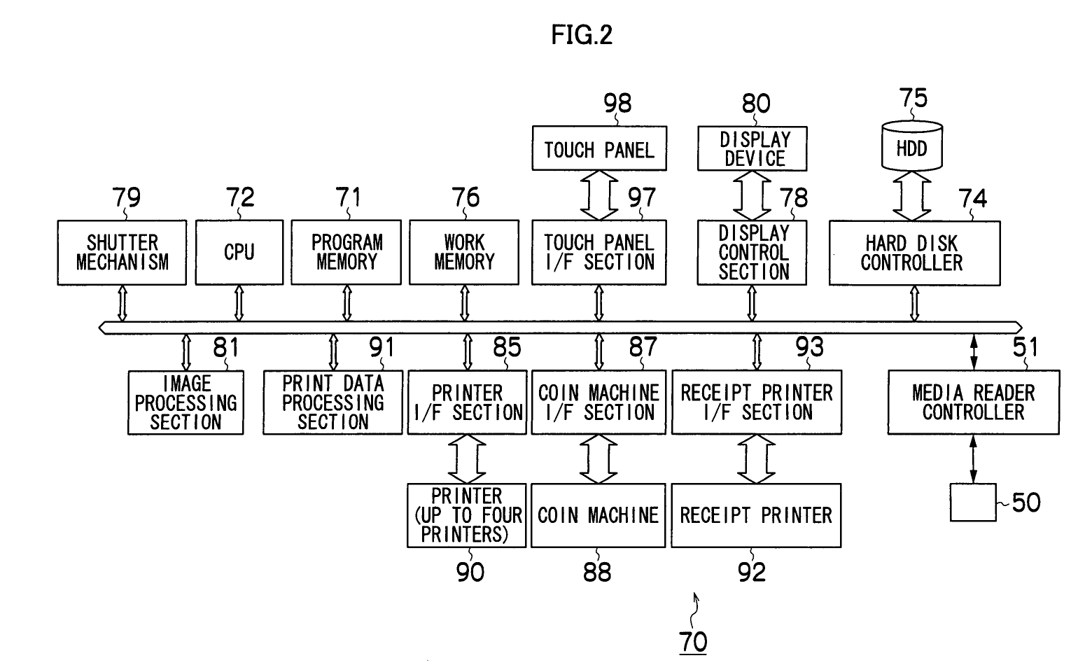

FIG. 1 is a front view of a point-of-sales print apparatus 70 according to the present invention. The point-of-sales print apparatus 70 is a machine to be used by a customer to insert a recording medium 50 (see FIG. 2) such as a SmartMedia into an insertion slot 89 thereof and throw in money to print a digital image stored in the recording medium 50 onto a print medium such as TA paper. The point-of-sales print apparatus 70 is a point-of-sales information terminal installed at the front of various stores such as a photo shop, a bookstore and a supermarket, and it is usually used by a customer who purchases a print for himself without help of a salesperson.

At the front of the point-of-sales print apparatus 70, there is arranged a liquid crystal display device 80 with a touch panel 98 laminated thereon. A customer inputs necessary information such as the print size and the number of prints by operating the touch panel 98 while viewing the display device 80. Inside the point-of-sales print apparatus 70, there are installed one or more printers 90 (see FIG. 2), and each of the printers 90 prints a digital image. Up to four printers 90 are arranged in the point-of-sales print apparatus 70 of this embodiment. At the external front of the point-of-sales print apparatus 70, there is arranged a discharge port 82 from which a printed print medium is to be discharged. There are also provided a coin slot 84 through which cash money such as coins and bills (a settlement medium such as a prepaid card equivalent to cash money is also possible) are to be thrown into a coin machine 88 to be described later, and a coin return slot 86 for the coin machine 88 to return change to the customer. There is provided a shutter mechanism 79 for opening and closing the coin slot 84 near the coin slot 84 (see FIG. 2), so that it is possible to completely prevent money from being thrown in by blocking the coin slot 84 with the shutter mechanism 79.

FIG. 2 is a block diagram showing the hardware configuration of the point-of-sales print apparatus 70.

When a customer inserts a recording medium 50 into the insertion slot 89, a hard disk controller 74 loads control software recorded on a hard disk (HDD) 75 to a program memory 71. On the recording medium 50, image data compressed in a predetermined format is recorded. When instructing a media reader controller 51 to read image data and acquiring required image data from the recording medium 50, a CPU 72 expands the image data to restore it to the original image data by means of an image processing section 81. Furthermore, the CPU 72 performs required image processing by means of the image processing section 81 and stores the image data in a work memory 76.

The customer inputs various information about a print order, such as selection of an image to be printed, the number of prints and the kind of print, from the touch panel 98. As for the kind of print, “digital camera print”, “division print”, “seal print”, “index print” and the like can be specified. As for the division print, “division into sixteen”, “division into four”, “division into two”, “without division” and the like can be specified as the number into which the screen is divided. As for the print size, selection can be made among “card size”, “L size”, “CD size”, “2L size” and the like. Hereinafter, the information about a print order inputted from the touch panel 98 will be referred to as order information.

By the customer depressing a desired position on the touch panel 98, the order information such as the print size and the number of prints is converted to an electric signal corresponding to the position and inputted into the CPU 72 via a touch panel interface section 97.

The inputted information is displayed on the display device 80. The display device 80 is operated by a display control section 78. The coin machine 88 converts the amount displayed on the display device 80 to an electric signal based on the information inputted from the touch panel 98 and inputs it into the CPU 72 via a coin machine IF section 87. The CPU 72 checks whether the customer has thrown in a necessary amount. If the necessary amount has been thrown in, a print data processing section 91 creates print job data from the image data stored in the work memory 76 and sends the print job data to each of the printers 90 via a printer I/F section 85. The sequence of these controls is performed by the CPU 72.

A print method referred to a TA (thermo autochrome) method is adopted by each of the printers 90. In this method, TA paper is used which has a characteristic that it is colored by being heated and the colors are fixed by the paper being exposed to light with a predetermined wave length.

When print ends, a receipt is outputted from a receipt printer 92, on which the amount thrown into the coin machine 88, the amount of returned change, and the like are described. The content to be printed by the receipt printer 92 is specified by the CPU 72 via a receipt printer I/F section 93.

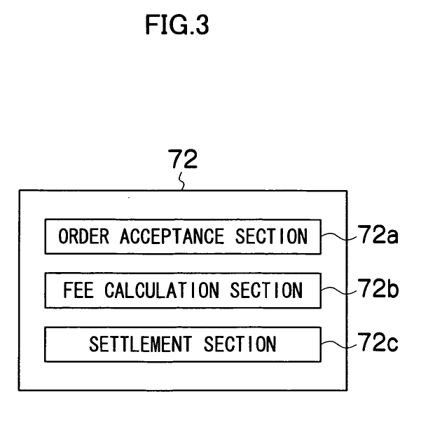

FIG. 3 is a block diagram showing a program to be executed by the CPU 72. The CPU 72 executes an order acceptance section 72a, a fee calculation section 72b and a settlement section 72c which are programs. These programs are stored in the HDD 75, and the CPU 72 reads the programs into the program memory 71 and executes them as appropriate. Details of the content of processing to be performed by these programs will be described later.

The order acceptance section 72a accepts input of order information through an operation of the touch panel 98. The order information accepted by the order acceptance section 72a is temporarily stored in the work memory 76 or the HDD 75. The fee calculation section 72b calculates a print fee based on the content of the print order information. For example, if it is assumed that the unit price per print of an image is a yen and the number of prints is b, then the print fee is calculated by multiplying a by b.

The settlement section 72c settles the print fee by subtracting the print fee from the amount of cash money thrown into the coin machine 88. The amount of the cash money thrown into the coin machine 88 is inputted into the settlement section 72c from the coin machine 88, and the settlement section 72c temporarily stores the inputted amount in the work memory 76 or the HDD 75.

The point-of-sales print apparatus 70 according to the present invention accepts cash money being thrown in at any time while print order information is inputted. Furthermore, if it accepts an instruction to start print and the amount thrown in is equal to or above the print fee then, it creates print job data in accordance with the inputted order information, performs print output, and waits for input of new order information.

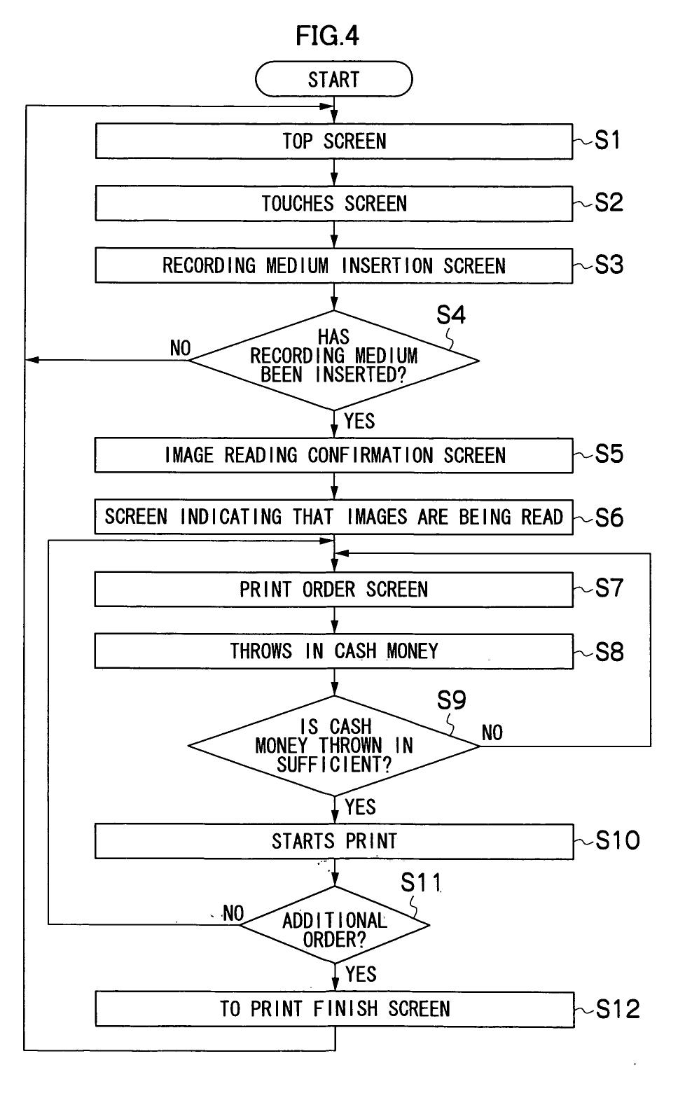

FIG. 4 is a flowchart illustrating the flow of the print order processing by the point-of-sales print apparatus 70.

First, the display control section 78 displays a top menu screen on the display device 80 (S1). On the top menu screen, selection among various services, such as a print service and a medium recording service, can be made by performing an operation of depressing the touch panel 98 (S2). If the print service is selected on the screen, then the display control section 78 displays a screen for prompting insertion of a recording medium 50 into the insertion slot 89 on the display device 80 (S3).

The order acceptance section 72a determines whether a recording medium 50 has been inserted in the insertion slot 89 (S4). If it is determined that it has been inserted, then the process proceeds to S5, and otherwise, the process returns to S1.

The order acceptance section 72a accepts an input for confirming whether or not to start reading of images from the recording medium 50, from the touch panel 98 (S5). If the confirmation is inputted, thumbnail images are read from the recording medium 50 by the media reader controller 51. The display control section 78 displays an indication to the effect that images are being read on the display device 80 until the reading is completed (S6). When the reading of the images is completed, the display control section 78 displays a print order screen for inputting order information on the display device 80 (S7).

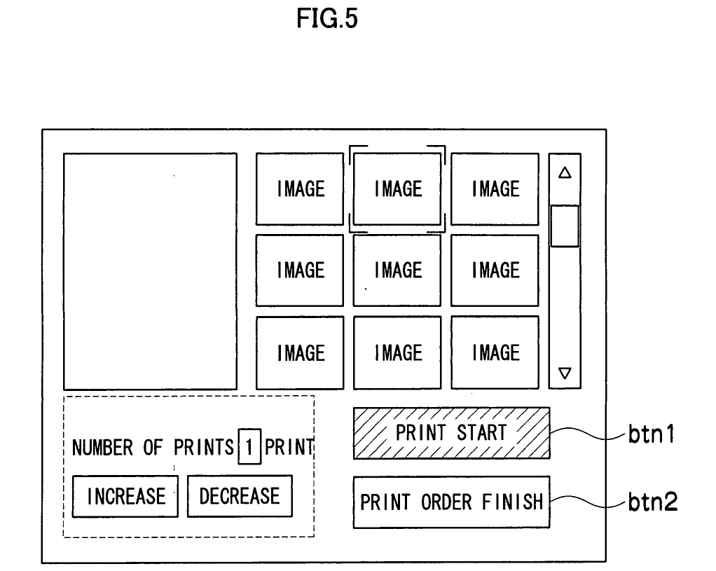

FIG. 5 is a display example of the print order screen. On the screen, the thumbnail images read from the recording medium 50 are displayed as a list, and the customer can operate the touch panel 98 by depressing the display portion of a graphical user interface (GUI) to input desired order information such as selection of a thumbnail image, specification of the number of prints and the like. The order acceptance section 72a stores the inputted order information in the work memory 76.

On the screen, there are displayed a “print start” button btn1, which is a GUI for instructing start of print output and a “print order finish” button btn2 are displayed. However, these buttons are disabled and cannot accept a depressing operation unless the amount thrown into the coin machine 88 is equal to or above the print fee.

That is, the settlement section 72c controls the shutter mechanism 79 so that cash money can be thrown in at any timing while print order information is inputted. The settlement section 72c controls the shutter mechanism 79 to close the coin slot 84 and prohibit cash money from being thrown in during the period from display of the top menu to reading of images (S1 to S6). When reading of images is completed (S7), the settlement section 72c controls the shutter mechanism 79 to open the coin slot 84, release the prohibition of throwing in of cash money and enable cash money to be thrown in at any time while print order information is inputted. If the prohibition of throwing in of cash money is released, the customer can throw in cash money at any timing (S8).

When cash money is thrown in, the fee calculation section 72b calculates a print fee in accordance with order information currently inputted. Then, it compares the amount appropriated to payment, which is the amount of cash money thrown in, with the print fee and determines whether or not the amount appropriated to payment is equal to or above the print fee (S9). If it is determined that the amount appropriated to payment is equal to or above the print fee, then the process proceeds to S10, and otherwise, the process returns to S7.

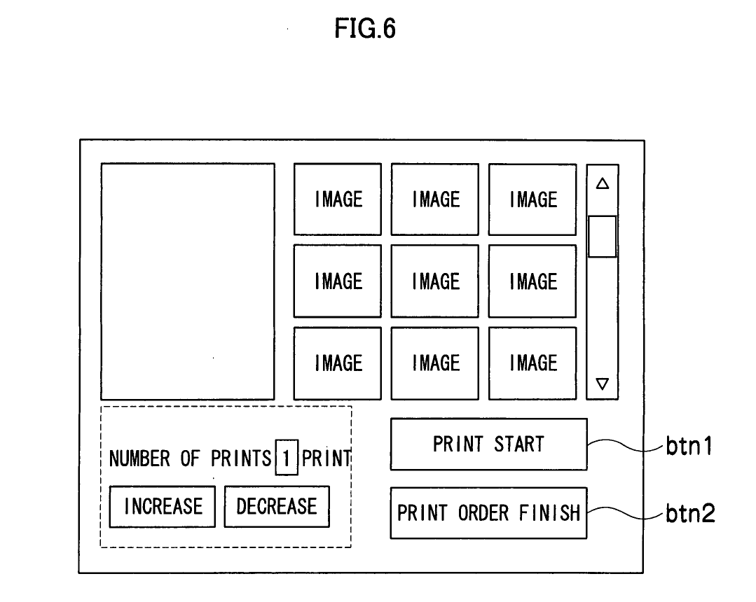

The order acceptance section 72a enables operation of the “print start” button btn1, that is, enables acceptance of an operation of depressing the “print start” button btn1 (S10). In response to this, the display control section 78 displays an indication to the effect that an instruction to start print output can be inputted. The content of the display may be arbitrary. For example, as shown in FIG. 6, the tone of the “print start” button btn1 may be changed. Alternatively, a message box may be pop-up displayed to inform that the “print start” button btn1 can be operated.

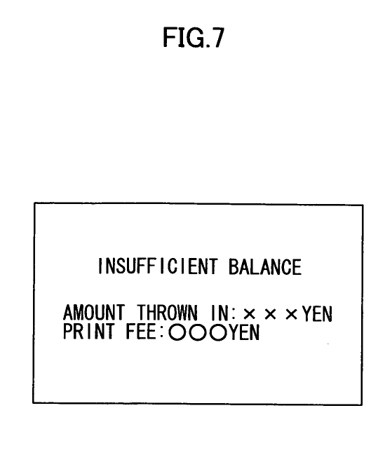

As shown in FIG. 7, in the case where it is determined that the amount appropriated to payment is below the print fee, it is possible that the display control section 78 displays a warning on the display device 80 and then the process returns to S7.

After enabling operation of the “print start” button btn1, the order acceptance section 72a waits for depression of the “print start” button btn1. When the order acceptance section 72a accepts depression of the “print start” button btn1, the print data processing section 91 creates print job data for printing the specified number of prints of the original image of a selected thumbnail image, of a specified kind, in accordance with the inputted order information, and sends the print job data to each of the printers 90 via the printer I/F section 85. Each of the printers 90 prints the image in accordance with the print job data. The printed matters are discharged from the discharge port 82. When accepting depression of the “print start” button btn1, the order acceptance section 72a disables the “print start” button btn1, that is, disables an operation of depressing the “print start” button btn1.

The order acceptance section 72a waits for input of an instruction to finish the print order by means of an operation of depressing the “print order finish” button btn2 (S11). The process returns to S7 unless the order acceptance section 72a accepts depression of the “print order finish” button btn2, and the order acceptance section 72a waits for input of new order information from the print order screen. When the order acceptance section 72a accepts depression of the “print order finish” button btn2, the process proceeds to S12, where an indication is displayed on the display device 80 to the effect that the print order processing ends. At the same time, the fee calculation section 72b calculates the total amount of the print fee in accordance with the order information for which print output has ended, and the settlement section 72c returns the amount obtained by subtracting the total amount of the print fee from the amount appropriated to payment as change, from the coin return slot 86. Then, the process returns to S1.

As described above, the point-of-sales print apparatus 70 according to the present invention makes it possible to throw in cash money at any timing while print order information is inputted and to input new order information as far as the cash money thrown in is equal to or above the print fee. Accordingly, it is possible to sequentially output prints based on order information sequentially inputted by a customer. Especially, it is also possible to input a new order information while print output in accordance with print order information inputted previously is being performed.

What is claimed is:

1. A point-of-sales print apparatus having an order acceptance section which accepts input of a print order information including specification of an image to be printed and the number of prints and input of an instruction to start print output, a fee calculation section which calculates a print fee based on the content of the print order information, a settlement section to which an amount appropriated to payment, an amount to be appropriated to payment for the print fee, is inputted and which settles the print fee from the amount appropriated to payment, and a print output section which outputs prints of an image in accordance with the print order information in response to the settlement, wherein
the settlement section accepts input of the amount appropriated to payment at any timing while the print order information is inputted,
the order acceptance section enables input of an instruction to start print output in accordance with the print order information if the amount appropriated to payment is equal to or above the print fee,
the print output section performs print output in accordance with the print order information, in response to input of the instruction to start print output, and
the order acceptance section further accepts a new print order information after the instruction to start print output is inputted.

2. The point-of-sales print apparatus according to claim 1, wherein
the order acceptance section accepts input of an instruction to finish a print order, and
the settlement section settles the print fee in response to input of the instruction to finish the print order.

3. The point-of-sales print apparatus according to claim 1, further comprising:
a display section which displays an indication to the effect that input of the instruction to start print output is possible if the amount appropriated to payment is equal to or above the print fee.

4. The point-of-sales print apparatus according to claim 2, further comprising:
a display section which displays an indication to the effect that input of the instruction to start print output is possible if the amount appropriated to payment is equal to or above the print fee.

5. The point-of-sales print apparatus according to claim 3, wherein the display section displays a warning if the amount appropriated to payment is below the print fee.

6. The point-of-sales print apparatus according to claim 4, wherein the display section displays a warning if the amount appropriated to payment is below the print fee.

7. A print order processing method, comprising the steps of:
accepting input of a print order information including specification of an image to be printed and the number of prints;
accepting input of an amount appropriated to payment, an amount to be appropriated to payment for a print fee at any timing while the print order information is inputted;
calculating a print fee based on the content of the print order information;
enabling input of an instruction to start print output in accordance with the print order information if the amount appropriated to payment is equal to or above the print fee;
performing print output in accordance with the print order information, in response to input of the instruction to start print output; and
further accepting a new print order information after the instruction to start print output is inputted.

8. A print order processing program which causes a computer to perform the steps of:
accepting input of a print order information including specification of an image to be printed and the number of prints;
accepting input of an amount appropriated to payment, an amount to be appropriated to payment for a print fee at any timing while the print order information is inputted;
calculating a print fee based on a content of the print order information;
enabling input of an instruction to start print output in accordance with the print order information if the amount appropriated to payment is equal to or above the print fee;
performing print output in accordance with the print order information, in response to input of the instruction to start print output; and
further accepting a new print order information after the instruction to start print output is inputted.
